(19) United States
(12) Patent Application Publication
(10) Pub. No.: US 2007/0085848 A1
(43) Pub. Date: Apr. 19, 2007

(54) Plasma display device and a power supply thereof

(76) Inventors: Seong-Joon Jeong, Suwon-si (KR); Woo-Joon Chung, Suwon-si (KR); Jin-Ho Yang, Suwon-si (KR); Tae-Seong Kim, Suwon-si (KR); Suk-Jae Park, Suwon-si (KR); Seung-Min Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/583,468

(22) Filed: Oct. 18, 2006

(30) Foreign Application Priority Data
Oct. 18, 2005 (KR) KR10-2005-0098024

(51) Int. Cl. G09G 5/00

(52) U.S. Cl. 345/211

(57) ABSTRACT

A plasma display device and a power supply thereof having a fewer number of power sources in the plasma display device is disclosed. The power supply generates a voltage corresponding to a Ve power source by using a variable resistance through a voltage distribution principle without including a Ve power source. In addition, since a power supply circuit including a thermistor is used in order to correspond to a discharge firing voltage which is changed by a temperature, a sustain discharge is stably generated by adjusting a Ve voltage without including a Ve power source.

### CROSS-REFERENCE TO RELATED APPLICATION

This application claims priority to and the benefit of Korean Patent Application No. 10-2005-0098024 filed in the Korean Intellectual Property Office on Oct. 18, 2005, the entire content of which is incorporated herein by reference.

### BACKGROUND OF THE INVENTION

1. Field of the Invention

The present invention relates to a plasma display device, and more particularly to a power supply for supplying a voltage to a plasma display device.

2. Description of the Related Technology

A plasma display device uses plasma generated by gas discharge to display characters or images. The display device includes, depending on its size, a number of pixels ranging from hundreds or less to millions or more arranged in a matrix pattern. Such a plasma display device is classified as a direct current (DC) type or an alternating current (AC) type according to its discharge cell structure and the waveform of the driving voltage applied thereto.

A DC plasma display device has electrodes exposed to a discharge gas space, and it accordingly allows a DC to flow through the discharge gas space when a voltage is applied. Therefore, such a DC plasma display device problematically requires a resistor for limiting the current. On the other hand, an AC plasma display device has electrodes covered with a dielectric layer that forms a capacitor to limit the current and protect the electrodes from the impact of ions during discharge. Accordingly, the AC plasma display device has a longer lifetime than the DC plasma display device.

An updating period of an entire frame of such a plasma display device is divided into a plurality of subfields or regions (e.g., one or more rows and/or columns of pixels) having weight values, where an updating period of each subfield includes a reset period, an address period, and a sustain period. The reset period is a period for resetting the state of discharge cells so that an address discharge may be stably performed, and the address period is a period for selecting discharge cells to be turned on and discharge cells not to be turned on. In addition, the sustain period is a period for applying a sustain discharge to the addressed cells to be turned on so as to actually display images.

In order to perform the above-mentioned operations, a power supply for a plasma display device supplies various voltages, such as Vs, Vset, Ve, Va, Vnf, VscH, or VscL to a driving circuit, because those various voltages are necessary for creating a plasma discharge. In addition, the power supply for the plasma display device also supplies a voltage to an image processor, a fan, an audio unit, and a control circuit.

However, when the plasma display device includes additional power sources for respectively generating voltages such Vs, Ve, Va, etc., the cost of the power supply for the plasma display device may be increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a plasma display device and a power supply thereof having a fewer number of power sources in the plasma display device.

An embodiment provides a power supply for generating a plurality of voltages in a plasma display device. The power supply includes a power source configured to supply a first voltage to the plasma display device and a transistor in which a drain is electrically connected to the power source. The power supply also includes a first resistor in which first and second ends are respectively connected to the power source and a gate of the transistor, a second resistor in which a first end is connected to the second end of the first resistor and a second end is electrically connected to a reference power source, wherein the resistances of the first and second resistors are configured to supply a second voltage lower than the first voltage to the gate of the transistor, and a capacitor of which a first end is electrically connected to a source of the transistor and a second end is electrically connected to the reference power source. In this embodiment, at least one resistance of the first or second resistors is configured to be changed according to the temperature of the plasma display device such that a third voltage is generated at a first end of the capacitor and is supplied to the plasma display device.

Another embodiment provides a plasma display device. The plasma display device of this embodiment includes a plasma display panel (PDP) having a plurality of first electrodes, a plurality of second electrodes, a plurality of third electrodes intersecting the first and second electrodes, and a plurality of discharge cells formed at intersections of the first, second, and third electrodes. The plasma display device also includes a driver configured to provide a gradually decreasing voltage to the plurality of second electrodes during a voltage falling period of a reset period, wherein the gradually decreasing voltage decreases to a first voltage level, the driver being further configured to alternately apply a second voltage to the plurality of first electrodes and the plurality of second electrodes during a sustain period, and to apply a third voltage to the plurality of first electrodes during the address period and the voltage falling period. The plasma display device further includes a power supply including a power source configured to supply the second voltage to the plurality of first and second electrodes, a transistor of which a drain is electrically connected to the power source, a first resistor of which first and second ends are respectively connected to the power source and a gate of the transistor, and wherein the first resistor is configured such that a resistance thereof is changed according to the temperature of the PDP, a second resistor of which a first end is connected to the second end of the first resistor and a second end is electrically connected to a reference power source, wherein the resistances of the first resistor and the second resistor are configured to supply a fourth voltage that is lower than the second voltage to the gate of the transistor. The power supply also includes a capacitor of which a first end is connected to a source of the transistor, a second end is electrically connected to the reference power source, and the third voltage is generated at the first end of the capacitor and is applied to the plurality of first electrodes.

### BRIEF DESCRIPTION OF THE DRAWINGS

FIG. 1 is a drawing of a plasma display device according to an exemplary embodiment of the present invention.

FIG. 2 is an example of a driving waveform diagram for driving the plasma display device of FIG. 1.

FIG. 3 is a drawing showing a portion of an embodiment of an output terminal of a power source for driving the plasma display device of FIG. 1.

FIG. 4 is a drawing showing a portion of another embodiment of an output terminal of a power source for driving the plasma display device of FIG. 1.

### DETAILED DESCRIPTION OF CERTAIN INVENTIVE EMBODIMENTS

Exemplary embodiments of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

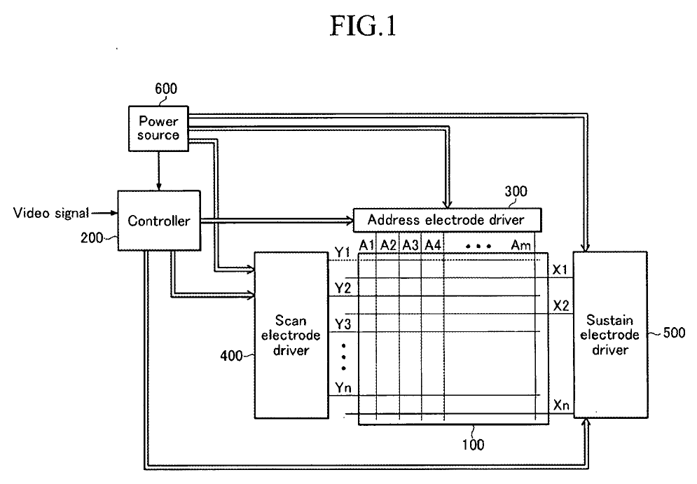

Hereinafter, a schematic structure of a plasma display device according to an exemplary embodiment of the present invention will be described in detail with reference to FIG. 1. FIG. 1 is a drawing of a plasma display device according to an exemplary embodiment of the present invention. As shown in FIG. 1, a plasma display device according to an embodiment of the present invention includes a plasma display panel (PDP) 100, a controller 200, an address electrode driver 300, a scan electrode driver 400, a sustain electrode driver 500, and a power supply 600.

The PDP 100 includes a plurality of address electrodes A1-Am formed in a column direction, and a plurality of scan electrodes Y1-Yn and a plurality of sustain electrode X1-Xn formed in a row direction. Each of the sustain electrodes X corresponds to one of the scan electrodes Y, and ends of X and Y electrodes are connected electrically to the sustain electrode driver 500 and the scan electrode driver 400, respectively. In addition, The PDP 100 includes a first substrate (not shown) on which the sustain electrodes X1-Xn and the scan electrodes Y1-Yn are arranged, and a second substrate (not shown) on which the address electrodes A1-Am are arranged. The two substrates are arranged to face each other with discharge gas spaces therebetween so that the scan electrodes Y1-Yn and the sustain electrodes X1-Xn may respectively cross the address electrodes A1-Am. In this example, discharge gas spaces at intersecting regions of the address electrodes A1-Am and the sustain and scan electrodes X1-Xn and Y1-Yn may form discharge cells.

The controller 200 receives a video signal (e.g., from an external source) and outputs an address electrode driving control signal, a sustain electrode X driving control signal, and a scan electrode Y driving control signal. The controller 200 updates an entire frame by updating a plurality of subfields or regions (e.g., one or more rows and/or columns) where the update period of each subfield includes a reset period, an address period, and a sustain period.

The address driver 300 receives the address electrode driving control signal from the controller 200 and applies a display data signal to the respective address electrodes A for selecting a cell to be activated.

The scan electrode driver 400 receives the scan electrode Y driving control signal from the controller 200 and applies a driving voltage to the scan electrodes Y1-Yn.

The sustain electrode driver 500 receives the sustain electrode X driving control signal from the controller 200 and applies a driving voltage to the sustain electrodes X1-Xn.

The power supply 600 supplies the voltages necessary for driving the plasma display device 100, with the controller 200 and the drivers 300, 400, and 500.

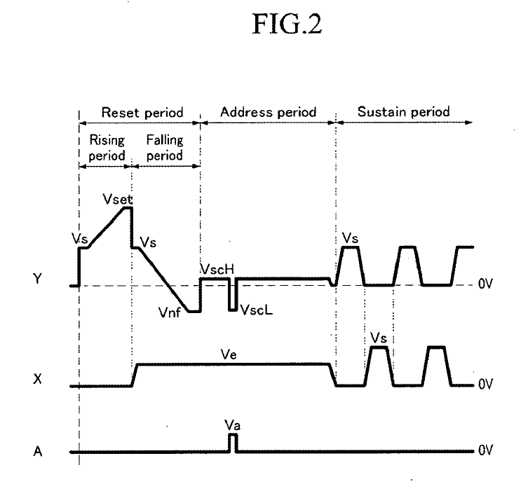

FIG. 2 shows voltage waveforms applied to the address electrodes A1-Am, the sustain electrodes X1-Xn, and the scan electrodes Y1-Yn, respectively, in each subfield. The voltage waveforms are applied to the electrodes of a discharge cell formed in a discharge gas space at intersecting regions of an address electrode, a sustain electrode, and a scan electrode.

FIG. 2 is a driving waveform diagram of a plasma display device according to an exemplary embodiment of the present invention. FIG. 2 denotes only one subfield among a plurality of subfields. As shown in FIG. 2, the update period of each subfield includes a reset period, an address period, and a sustain period. The reset period includes a rising period and a falling period. During the rising period of the reset period in a first subfield, a rising waveform that gradually increases from a voltage Vs to a voltage Vset is applied to the scan electrode Y while the sustain electrode X is maintained at 0V. At this time, a respective weak reset discharge occurs in the discharge cells from the scan electrode Y to the address electrode A and to the sustain electrode X. Accordingly, negative wall charges are accumulated at the Y electrode and positive wall charges are concurrently accumulated at the address electrode A and the sustain electrode X.

Subsequently, during the falling period of the reset period in the first subfield, a falling waveform that gradually decreases from the voltage Vs to the voltage Vnf is applied to the scan electrode Y while the sustain electrode X is maintained at the voltage Ve. While the voltage of the scan electrode Y decreases, a weak reset discharge occurs between the scan electrode Y and sustain electrode X and between the scan electrode Y and the address electrode A. Accordingly, negative wall charges formed on the scan electrode Y and positive wall charges formed on the sustain electrode X and the address electrode A can be eliminated. In general, the voltage difference (Vnf-Ve) is set to be the firing voltage Vfxy between the scan electrode Y and the sustain electrode X. Accordingly, the wall voltage between the scan electrode Y and the sustain electrode X becomes almost 0V, and the cells to be turned off in the address period are prevented from being misfired in the sustain period.

Subsequently, in order to select cells to be activated, a scan pulse having a voltage VscL and an address pulse having a voltage Va are respectively applied to the scan electrode Y and the sustain electrode A during the address period. Non-selected Y electrodes are biased at a voltage VscH that is higher than the voltage VscL, and the reference voltage Va applied to the address electrode in the turn-off cells (i.e., cells to be turned off). Then an address discharge is generated on a cell due to wall voltages which are generated by both the wall charges formed on the address electrode A and scan electrode Y and the difference between the address voltage Va and the scan voltage VscL. As a result, positive (+) wall charges are formed on the scan electrode Y and negative (−) wall charges are formed on the sustain electrode X and the address electrode A.

Subsequently, during the sustain period of the first subfield, a sustain discharge pulse of voltage Vs is alternately applied to the scan electrode Y and the sustain electrode X. At this time, since the wall voltage is generated between the scan electrode Y and the sustain electrode Y by the address discharge in the address period, a discharge is generated between the scan electrode Y and the sustain electrode X due to the wall voltage and the voltage Vs. Subsequently, the processes of alternately applying the sustain pulses having the voltage Vs to the scan electrode Y and the sustain electrode X are repeated a number of times corresponding to a weight value of the subfield. When the sustain period of the first subfield ends, driving of a second subfield starts.

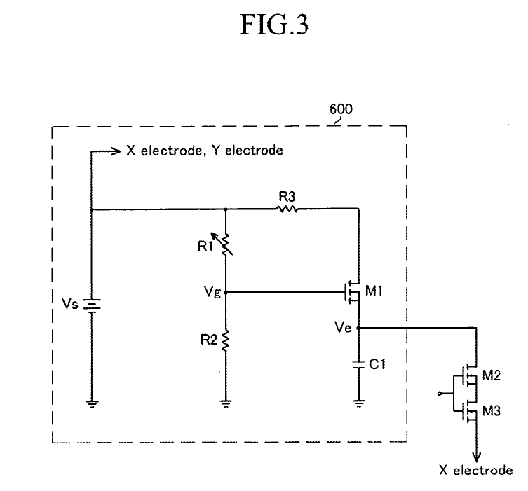

A method of generating a voltage Ve in the power source 600 according to the first exemplary embodiment of the present invention will be described with reference to FIG. 3. The method of generating the voltage Ve in the power source 600 is performed by using a Vs power source and an additional circuit without an additional dedicated Ve power source.

FIG. 3 is a drawing showing a portion of an embodiment of an output terminal of a power source for driving the plasma display device of FIG. 1. As shown in FIG. 3, the power supply 600 of the plasma display device includes a power source for supplying a sustain discharge voltage (Vs) (hereinafter, referred to as “Vs power source”), resistors (R2, R3), a variable resistor (R1), a capacitor (C1), and transistors (M1, M2, M3).

A negative terminal of the Vs power source is connected to a ground, and a positive terminal thereof is connected to a first end of the variable resistor R1. A first end of the resistor R2 is connected to a second end of the variable resistor R1, and a second end of the resistor R2 is connected to a reference power source such as a ground. In addition, a first end of the resistor R3 is connected to the positive terminal of the Vs power source, and a second end thereof is connected to a drain of the transistor M1.

A gate of the transistor M1 is connected to the second end of the variable resistor R1, and a source thereof is connected to a drain of the transistor M2. In addition, a first end of the capacitor C1 is connected to the source of the transistor M1, and a second end thereof is connected to the reference power source.

A source of the transistor M2 and a source of the transistor M3 are connected to each other, and a gate of the transistor M2 and a gate of the transistor M3 are also connected each other. Accordingly, a back-to-back switch is thus formed. In this way, the transistors M2 and M3 form a switch for supplying the voltage Ve to the sustain electrode X as shown in FIG. 2. Referring to FIG. 3, when the voltage Vs is higher than the voltage Ve, the transistors M2 and M3 are connected to each other with the back-to-back scheme such that currents are prevented from flowing into the Ve power source when the voltage Vs is being supplied to the PDP 100. However, in some embodiments, the switch may be formed by using only one transistor rather than the back-to-back transistors.

In addition, a drain of the transistor M3 is connected to the sustain electrodes X1-Xn of the PDP 100.

The Vs power source is used for applying the voltage Vs to the scan electrode Y during the reset period, and for applying the voltage pulse Vs alternately to the sustain electrode X and the scan electrode Y during the sustain period.

As shown in FIG. 3, since the Vs power source is connected to the variable resistor R1 and the resistor R2, a relationship between a gate voltage Vg of the transistor M1 and the sustain voltage Vs can be described by the following Equation 1 according to the voltage divider rule. Here, the gate voltage Vg is connected to the second end of the variable resistor R1 and the first end of the resistor R2.

$${V}_{g} = \frac{R2}{R1 + R2} Vs \qquad ( Equation 1 )$$

As shown in Equation 1, the gate voltage Vg is determined according to resistances of the variable resistor R1 and the resistor R2. In particular, since the resistance of the variable resistor R1 can be changed, the gate voltage Vg of the transistor M1 can be adjusted by the variable resistor R1. In addition, the resistor R3 can be connected between the Vs power source and the drain of the transistor M1 in order to prevent momentary inrush currents.

According to the embodiment shown in FIG. 3, the voltage Ve applied at the first end of the capacitor C1 is applied to the sustain electrode X during the address period and the falling period of the reset period without using an additional Ve power source. Since the second end of the capacitor C1 is connected to the ground, the voltage charged at the capacitor C1 has the same voltage level as the source voltage Ve of the transistor M1.

It is assumed that the voltage is not charged at the capacitor C1. Since the capacitor C1 is connected to the reference power source (e.g., a ground with a voltage level of 0V), when it is not yet being charged with the voltage, the source voltage Ve of the transistor M1 also has the voltage level of 0V. At this time, when the voltage Ve is applied to the capacitor C1, the predetermined voltage Vg is applied to the gate of the transistor M1, and then the transistor M1 is turned on because the voltage Vg is greater than a threshold gate-source voltage Vth of the transistor M1. That is, as shown in Equation 1, the voltage Vg that is necessary for the gate of the transistor M1 can be applied thereto by adjusting the resistance of the variable resistor R1.

Therefore, since the currents may flow to the source of the transistor M1 when the transistor M1 is turned on, the capacitor C1 starts to be charged with the voltage Ve. As the capacitor C1 is charged with the voltage, the source voltage Ve of the transistor M1 is increased up to the same level of the voltage charging the capacitor C1.

When the source voltage Ve of the transistor M1 is increased up to the predetermined voltage level, the transistor is turned off at the moment that the gate-source voltage of the transistor M1 becomes lower than the threshold voltage Vth. In addition, the voltage Ve generated until the turn-off of the transistor M1 is applied to the sustain electrode X during the address period and the falling period of the reset period as shown in FIG. 2 so as to drive the plasma display device.

According to the first exemplary embodiment of the present invention, without using an additional Ve power source, the voltage generated by the voltage Ve applied at the first end of the capacitor C1 can be applied to the sustain electrode X so as to drive the plasma display device.

As shown in FIG. 2, the voltage difference (Vnf-Ve) is set to be the discharge firing voltage (Vfxy) between the scan electrode Y and the sustain electrode X. The discharge firing voltage (Vfxy) between the scan electrode Y and the sustain electrode X may vary according to the temperature of the PDP or the surroundings thereof (hereinafter, referred to as ‘PDP temperature’). The reasons for the variation of the discharge firing voltage (Vfxy) according to the PDP temperature are that MgO covering the scan electrode Y and the sustain electrode X has the effect of determining the discharge firing voltage (Vfxy), and that the forming conditions for MgO can be significantly affected by the PDP temperature. Generally, the discharge firing voltage (Vfxy) decreases as the PDP temperature rises, and increases as the PDP temperature falls.

If the Ve voltage and the Vnf voltage are set to the predetermined levels instead of being set to levels as determined by the change of the discharge firing voltage (Vfxy) due to the change of the PDP temperature, the wall charges between the scan electrode Y and the sustain electrode X may be excessively or insufficiently accumulated thereon. Accordingly, a misfiring may occur because the initial wall charges have not been properly accumulated. Therefore, the voltage difference (Vnf-Ve) needs to be adjusted based on the discharge firing voltage (Vfxy) as determined by the temperature of the PDP.

A method for supplying a driver with a voltage necessary for driving a plasma display device according to a second embodiment of the present invention will now be described in detail. The method for supplying a driver with a voltage is performed by adjusting the Ve voltage such that the difference between the Ve voltage and the Vnf voltage in the power source 600 is the same as the discharge firing voltage (Vfxy).

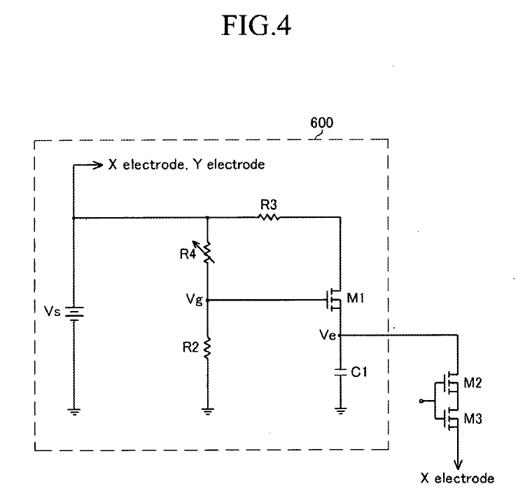

FIG. 4 is a drawing showing a portion of another embodiment of an output terminal of a power source for driving the plasma display device of FIG. 1. FIG. 4 can be the same as FIG. 3, except that a variable resistor R4 rather than the variable resistor R1 of FIG. 3 is used in FIG. 4. The variable resistor R4 may adjust across a range of resistances which are selected according to changes in temperature of the PDP.

The variable resistor R4 can be realized by using a thermistor. There are two types of thermistors: a positive temperature coefficient thermistor (PTC) wherein resistance increases with an increase in temperature, and a negative temperature coefficient thermistor (NTC) wherein resistance decreases with an increase in temperature. The PTC is used in the embodiment shown in FIG. 4.

As described above, since the discharge firing voltage (Vfxy) is changed according to the temperature of the PDP, the Ve voltage needs to be adjusted such that the discharge firing voltage (Vfxy) is substantially the same as the voltage difference (Ve-Vnf). Therefore, when the discharge firing voltage (Vfxy) increases due to a decrease of the temperature of the PDP, the Ve voltage is consequently increased because the resistance of the variable resistor R4 decreases. On the other hand, when the discharge firing voltage (Vfxy) decreases due to an increase of the temperature of the PDP, the Ve voltage decreases because the resistance of the variable resistor R4 increases. Therefore, the Ve voltage can be adjusted in a way that corresponds to the necessary discharge firing voltage (Vfxy) by using the PTC for the variable resistor R4.

The positions of the variable resistor R4 and the resistor R2 can be reversed from the configuration shown in FIG. 4. In this embodiment, a negative temperature coefficient thermistor (NTC) in which the resistance decreases as the temperature increases can be used therein. In addition, the resistor R2 may also be a variable resistor in which the resistance may be changed according to the temperature.

As described above, according to embodiments of the present invention, a power supply can be inexpensively formed by reducing the number of power sources in the power supply. In addition, the wall charges can be stably initialized in the reset period because the power supply circuit including a thermistor is used to adjust the Ve voltage corresponding to the discharge firing voltage which changes as a function of temperature.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A power supply for generating a plurality of voltages in a plasma display device, comprising:
a power source configured to supply a first voltage to the plasma display device;
a transistor in which a drain is electrically connected to the power source;
a first resistor in which first and second ends are respectively connected to the power source and a gate of the transistor;
a second resistor in which a first end is connected to the second end of the first resistor and a second end is electrically connected to a reference power source, wherein the resistances of the first and second resistors are configured to supply a second voltage lower than the first voltage to the gate of the transistor; and
a capacitor of which a first end is electrically connected to a source of the transistor and a second end is electrically connected to the reference power source,
wherein at least one resistance of the first or second resistors is configured to be changed according to the temperature of the plasma display device such that a third voltage is generated at a first end of the capacitor and is supplied to the plasma display device.

2. The power supply of the plasma display device of claim 1, further comprising a third resistor connected between the drain of the transistor and the power source.

3. The power supply of the plasma display device of claim 1, wherein the third voltage charges the capacitor when the transistor is turned on.

4. The power supply of the plasma display device of claim 1, wherein the third voltage is changed according to the temperature of the plasma display device.

5. The power supply of the plasma display device of claim 3, wherein the third voltage is changed according to the temperature of the plasma display device.

6. The power supply of the plasma display device of claim 1, wherein the reference power source is a ground.

7. The power supply of the plasma display device of claim 1, wherein the resistance of the first resistor is increased in response to an increase in the temperature of the plasma display device.

8. The power supply of the plasma display device of claim 1, wherein the resistance of the second resistor is decreased in response to an increase of the temperature of the plasma display device.

9. A plasma display device, comprising:
a plasma display panel (PDP) having a plurality of first electrodes, a plurality of second electrodes, a plurality of third electrodes intersecting the first and second electrodes, and a plurality of discharge cells formed at intersections of the first, second, and third electrodes;
a driver configured to provide a gradually decreasing voltage to the plurality of second electrodes during a voltage falling period of a reset period, wherein the gradually decreasing voltage decreases to a first voltage level, the driver being further configured to alternately apply a second voltage to the plurality of first electrodes and the plurality of second electrodes during a sustain period, and to apply a third voltage to the plurality of first electrodes during the address period and the voltage falling period; and
a power supply, comprising:
a power source configured to supply the second voltage to the plurality of first and second electrodes,
a transistor of which a drain is electrically connected to the power source,
a first resistor of which first and second ends are respectively connected to the power source and a gate of the transistor, and wherein the first resistor is configured such that a resistance thereof is changed according to the temperature of the PDP,
a second resistor of which a first end is connected to the second end of the first resistor and a second end is electrically connected to a reference power source, wherein the resistances of the first resistor and the second resistor are configured to supply a fourth voltage that is lower than the second voltage to the gate of the transistor, and
a capacitor of which a first end is connected to a source of the transistor, a second end is electrically connected to the reference power source, and the third voltage is generated at the first end of the capacitor and is applied to the plurality of first electrodes.

10. The plasma display device of claim 9, further comprising a third resistor connected between the drain of the transistor and the first power source.

11. The plasma display device of claim 9, wherein the second resistor is configured such that the resistance of the second resistor is changed according to the temperature of the PDP.

12. The plasma display device of claim 9, wherein the third voltage is changed according to the temperature of the PDP.

13. The plasma display device of claim 9, wherein the third voltage charges the capacitor when the transistor is turned on.

14. The plasma display device of claim 9, wherein the reference power source is a ground.

15. The plasma display device of claim 9, wherein the first voltage is lower than the fourth voltage.

16. The plasma display device of claim 9, wherein the third voltage is higher than the fourth voltage.

17. The plasma display device of claim 9, wherein the difference between the first voltage and the third voltage is the same as a discharge firing voltage of the discharge cells.

18. The plasma display device of claim 9, wherein the resistance of the first resistor is increased according to an increase of the temperature of the PDP.

19. A power supply for generating a plurality of voltages for a plasma display device, comprising:
means for supplying a first voltage to the plasma display device;
means for lowering the level of the first voltage supplying means to a second voltage level and for supplying the second voltage to the plasma display device; and
means for adjusting the second voltage level based on the temperature of the plasma display device.

20. The power supply of claim 19, further comprising means for selecting when to supply the first voltage and the second voltage to the plasma display device.
